(19) United States
(12) Patent Application Publication
(10) Pub. No.: US 2023/0203277 A1
(43) Pub. Date: Jun. 29, 2023

(54) RUBBER COMPOSITION AND PNEUMATIC TIRE USING SAME

(71) Applicant: TOYO TIRE CORPORATION, Itami-shi (JP)

(72) Inventor: Tatsuya Endo, Itami-shi (JP)

(73) Assignee: TOYO TIRE CORPORATION, Itami-shi (JP)

(21) Appl. No.: 17/983,467

(22) Filed: Nov. 9, 2022

(30) Foreign Application Priority Data
Dec. 27, 2021 (JP) 2021-213101

(51) Int. Cl. C08K 5/5415; C08K 3/36; B60C 1/00

(52) U.S. Cl. CPC C08K 5/5415; C08K 3/36; B60C 1/0016; B60C 1/0025; C08K 2201/014

(57) ABSTRACT

An object of the invention is to provide a rubber composition having excellent durability while maintaining a low fuel cost, and a pneumatic tire using the rubber composition. A rubber composition contains silica in a diene rubber. A deformation amount of a rubber component in a sample obtained by vulcanizing the rubber composition when the sample is elongated by 200% is obtained by a force curve measurement with an atomic force microscope, and a ratio of a rubber component having a deformation amount smaller than a weighted average value thereof is 70 vol % or more in the rubber component.

### BACKGROUND OF THE INVENTION

### 1. Field of the Invention

The present invention relates to a rubber composition and a pneumatic tire using the rubber composition.

### 2. Description of the Related Art

In recent years, rubber products such as a tire have been required to have further improved durability. In order to solve such a problem, for example, Japanese Patent No. 5212782 discloses that durability is improved by using a specific silane coupling agent.

Japanese Patent No. 3908368 discloses that by using a compound containing silica and two or more types of silane coupling agents, with a main chain skeleton of one of the silane coupling agents being polyethylene glycol or polypropylene glycol, and having an alkoxysilyl group at a terminal, a rubber composition for a tire tread having excellent balance in low electric resistance, low rolling resistance performance (low fuel cost), wet grip performance, mechanical strength, and processability is obtained.

However, there is room for further improvement in durability.

### SUMMARY OF THE INVENTION

In addition, when flexibility of the rubber composition is improved in order to improve the durability, the low fuel cost may not be obtained.

In view of the above points, an object of the invention is to provide a rubber composition having excellent durability while maintaining a low fuel cost, and a pneumatic tire using the rubber composition.

JP-A-2010-260920 discloses that excellent low heat generation, wear resistance, and wet grip performance can be obtained by using a specific silane coupling agent. Japanese Patent No. 4930661 discloses that by using a sulfur-containing silane coupling agent in combination with an alkyltriethoxysilane, aggregation and viscosity increase of silica can be prevented, and a tire excellent in wet performance and rolling resistance can be produced, but durability has not been evaluated.

A rubber composition according to the invention contains silica in a diene rubber, in which a deformation amount of a rubber component in a sample obtained by vulcanizing the rubber composition when the sample is elongated by 200% is obtained by a force curve measurement with an atomic force microscope, and a ratio of a rubber component having a deformation amount smaller than a weighted average value thereof is 70 vol % or more in the rubber component.

The rubber composition according to the invention can further contain a nitrogen-containing alkoxysilane and an alkylalkoxysilane.

A content of the silica can be 5 parts by mass to 150 parts by mass with respect to 100 parts by mass of the diene rubber, a total content of the nitrogen-containing alkoxysilane and the alkylalkoxysilane can be 3 mass % to 15 mass % with respect to the content of the silica, and a content ratio of the nitrogen-containing alkoxysilane in the total content of the nitrogen-containing alkoxysilane and the alkylalkoxysilane can be 10 mol % to 80 mol %.

The nitrogen-containing alkoxysilane can have at least one substituent selected from the group consisting of an amino group, a ureido group, an isocyanate group, a cyano group, an azide group, and an amide group.

The alkylalkoxysilane can be a compound represented by a Formula (1)

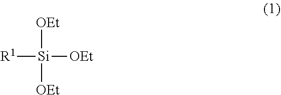

in the Formula (1), R¹ represents an alkyl group having 3 to 20 carbon atoms.

A pneumatic tire according to the invention is produced using the above rubber composition.

According to the rubber composition of the invention, excellent durability can be obtained while maintaining a low fuel cost.

### BRIEF DESCRIPTION OF THE DRAWINGS

FIG. 1 is a histogram showing a deformation amount of an obtained rubber component in a measurement with an atomic force microscope for Example 1; and

FIG. 2 is a histogram showing a deformation amount of an obtained rubber component in a measurement with an atomic force microscope for Comparative Example 1.

### DESCRIPTION OF EMBODIMENTS

Hereinafter, matters related to embodiments of the invention will be described in detail.

A rubber composition according to the present embodiment contains silica in a diene rubber.

The diene rubber according to the present embodiment is not particularly limited, and examples thereof include a natural rubber (NR), an isoprene rubber (IR), a butadiene rubber (BR), a styrene-butadiene rubber (SBR), a styrene-isoprene copolymer rubber, a butadiene-isoprene copolymer rubber, a styrene-isoprene-butadiene copolymer rubber, an acrylonitrile-butadiene rubber (NBR), a chloroprene rubber (CR), and a butyl rubber (IIR). Those obtained by modifying a terminal or a main chain as necessary (for example, a terminal-modified SBR) or those obtained by modification to impart desired characteristics (for example, a modified NR) are also included in the concepts of the diene rubber.

In one embodiment, the diene rubber preferably contains at least one selected from the group consisting of a natural rubber, a styrene-butadiene rubber, and a butadiene rubber. The diene rubber more preferably contains a styrene-butadiene rubber. For example, the diene rubber contains, in 100 parts by mass thereof, the styrene-butadiene rubber in an amount of preferably 50 parts by mass or more, and more preferably 70 parts by mass or more, and may contain only the styrene-butadiene rubber.

The styrene-butadiene rubber may be, for example, a solution-polymerized styrene-butadiene rubber (S-SBR) or an emulsion-polymerized styrene-butadiene rubber (E-SBR). As the styrene-butadiene rubber, a modified styrene-butadiene rubber in which a terminal or a main chain is modified as necessary (for example, an amine-modified SBR or a tin-modified SBR) may be used.

The silica according to the present embodiment is not particularly limited, and wet silica such as silica made by a wet-type precipitated method or silica made by a wet-type gel-method is preferably used. A content of the silica is not particularly limited, and is preferably 5 parts by mass to 150 parts by mass, and more preferably 30 parts by mass to 100 parts by mass with respect to 100 parts by mass of the diene rubber.

The rubber composition according to the present embodiment can further contain a nitrogen-containing alkoxysilane and an alkylalkoxysilane.

The nitrogen-containing alkoxysilane is an alkoxysilane containing nitrogen in molecules. Examples of the nitrogen-containing alkoxysilane include a compound having an alkoxy group bonded to silicon atoms, and a functional group selected from the group consisting of an amino group, a ureido group, an isocyanate group, a cyano group, an azide group, and an amide group. Those having nitrogen atoms in molecules among those generally called silane coupling agents are included.

Specific examples of the nitrogen-containing alkoxysilane include: aminoalkoxysilanes such as 3-aminopropylalkoxysilanes (for example, 3-aminopropyltriethoxysilane and 3-aminopropylhrimethoxysilane), and 3-(2-aminoethylamino)propylalkoxysilanes (for example, 3-(2-aminoethylamino)propyltriethoxysilane, 3-(2-aminoethylamnino)propyltrimcthoxysilane, and 3-(2-aminoethylamino)propylmethyldimethoxysilane); ureidoalkoxysilanes such as 3-ureidopropylalkoxysilanes (for example, 3-ureidopropyltriethoxysilanc, 3-ureidoprmpyltrinethoxysilane, 3-ureidopropylmethyldimethoxysilane, and 3-ureidopropylmethyldiethoxysilane), 2-urcidoethylalkoxysilanes (for example, 2-ureidoethyltrimethoxysilane, 2-ureidoethylriethoxysilane, and 2-ureidoethylmethyldimethoxysilane), and ureidomcthylalkoxysilancs (for example, ureidomethyltrimethoxysilane, urcidomethylmethyldimethoxysilane, ureidomethyltriethoxysilane, and ureidomcthylmethyldicthoxysilane); isocyanatoalkoxysilanes such as 3-isocyanatopropylalkoxysilane (for example, 3-isocyanatopropyltrimethoxysilane, 3-isocyanatopropyltriethoxysilanc, and 3-isocyanatopropyltripropoxysilane), 2-isocyanatoethylalkoxysilanes (for example, 2-isocyanatoethyltrimethoxysilane and 2-isocyanatoethyltricthoxysisilane), and isocyanatomethylalkoxysilanes (for example, isocyanatomethyltrimethoxysilane and isocyanatomethyltriethoxysilanc); cyanoalkoxysilanes (for example, 3-cyanopropyltrimethoxysilane and 3-cyanopropyltriethoxysilane); azidoalkylsilanes (for example, 3-azidopropyltriethoxysilane, 3-azidopropyltrimethoxysilane, and 11-azidoundecyltrimethoxysilane); and alkylsilylamide acids (for example, triethoxysilylpropyl maleamic acid). These may be used alone or in combination of two or more kinds thereof.

The alkylalkoxysilane according to the present embodiment may be an alkyldialkoxysilane, and preferably an alkyltrialkoxysilane. The alkylalkoxysilane preferably has an alkyl group having 3 to 20 carbon atoms, and specifically, an alkyltriethoxysilane represented by the following Formula (1) is preferably used. In the Formula (1), R¹ represents an alkyl group having 3 to 20 carbon atoms.

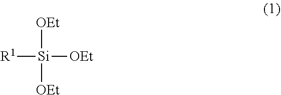

A total content of the nitrogen-containing alkoxysilane and the alkylalkoxysilane is preferably 3 mass % to 15 mass %, more preferably 3 mass % to 10 mass %, and still more preferably 3 muss % to 8 mass %, with respect to the content of the silica. That is, the total content of the nitrogen-containing alkoxysilane and the alkylalkoxysilane is preferably 3 parts by mass to 15 parts by mass, more preferably 3 parts by mass to 10 parts by mass, and still more preferably 3 parts by mass to 8 parts by mass, with respect to 100 parts by mass of the silica.

A content ratio of the nitrogen-containing alkoxysilane in the total content of the nitrogen-containing alkoxysilane and the alkylalkoxysilane is preferably 10 mol % to 80 mol %, more preferably 10 mol % to 60 mol %, and still more preferably 20 mol % to 50 mol %.

In addition to the above components, compounding chemicals such as a reinforcing filler, a process oil, a softener, a plasticizer, a wax, an antiaging agent, sulfur, and a vulcanization accelerator, which are generally used in the rubber industry, can be appropriately blended within a normal range in the rubber composition according to the present embodiment. A sulfur-containing silane coupling agent generally blended in the silica may be blended, but in one embodiment, it is preferable not to blend the sulfur-containing silane coupling agent.

As the reinforcing filler, carbon black may be blended in addition to the silica. That is, as the reinforcing filler, silica may be used alone, or carbon black and silica may be used in combination. A content of the reinforcing filler is not particularly limited, and is, for example, preferably 5 parts by mass to 150 parts by mass, more preferably 30 parts by mass to 100 parts by mass, and still more preferably 30 parts by mass to 80 parts by mass, with respect to 100 parts by mass of the diene rubber. Preferably, the filler contains silica as a main component, and a content of carbon black is preferably 10 parts by mass or less, and more preferably 5 parts by mass or less, with respect to 100 parts by mass of the diene rubber.

The carbon black is not particularly limited, and various known types can be used.

The rubber composition according to the present embodiment can be produced by kneading according to a common method by using a mixer such as a Banbury mixer, a kneader, or a roll that is generally used. In a first mixing stage, an additive other than a vulcanization agent and a vulcanization accelerator is added to and mixed with the diene rubber, and then as a final mixing stage, the vulcanization agent and the vulcanization accelerator are added to the obtained mixture to prepare a rubber composition.

In the rubber composition according to the present embodiment, a deformation amount of a rubber component in a sample obtained by vulcanizing the rubber composition when the sample is elongated by 200% is obtained by a force curve measurement with an atomic force microscope, and a ratio of a rubber component having a deformation amount smaller than an average value thereof is 70 vol % or more in the rubber component. In other words, by increasing a ratio of a (flexible) rubber component having a large deformation amount, the average value is shifted to a side where the deformation amount is large. Therefore, the rubber composition as a whole tends to have increased flexibility and excellent durability. An upper limit of the ratio of the rubber component having a deformation amount smaller than the average value is not particularly limited, and is preferably 90 vol % or less, more preferably 85 vol % or less, and still more preferably 80 vol % or less.

Conditions for the rubber composition and measurement conditions when the force curve measurement with an atomic force microscope is performed are described in Examples described later.

The rubber composition obtained in this manner can be applied to portions of a tire such as a tread or a sidewall of a pneumatic tire of various uses and sizes such as a tire for a passenger car or a large-sized tire for a truck or a bus. That is, the rubber composition is molded into a predetermined shape by, for example, extrusion according to a common method, and is combined with other parts to produce a green tire, and then the green tire is subjected to vulcanization molding at, for example, 140° C. to 180° C., whereby a pneumatic tire can be produced. Among these, it is particularly preferable to use the rubber composition as a blend for a tread of a tire.

### Examples

Hereinafter, Examples of the invention will be illustrated, but the invention is not limited to these Examples.

According to blending (parts by mass) shown in Tables 1 to 5, a rubber component was masticated for 30 seconds by using a labo mixer (300 cc) manufactured by Daihan Co., Ltd., then silica, a sulfur-containing silane coupling agent, a nitrogen-containing alkoxysilane, an alkylalkoxysilane, zinc oxide, and stearic acid were charged thereto, and the mixture was kneaded for 240 seconds and then discharged. Next, the discharged rubber composition was charged into the labo mixer, kneaded for 180 seconds, and then discharged. Further, the discharged rubber composition, sulfur, and a vulcanization accelerator were charged into the labo mixer, kneaded for 60 seconds, and discharged. The obtained unvulcanized rubber composition was subjected to sheeting by using two rolls so as to have a thickness of 2 mm, and then subjected to vulcanization pressing at 160° C. for 20 minutes to obtain a vulcanized sample.

Details of each component in Tables 1 to 5 are as follows.
S-SBR: “HPR350” manufactured by JSR Corporation, terminal amine-modified S-SBR
Silica: “Nipsil AQ” manufactured by Tosoh Corporation
Zinc oxide: “Zinc Oxide Grade 3” manufactured by Mitsui Mining & Smelting Co., Ltd.
Stearic acid: “LUNAC S-20” manufactured by Kao Corporation
Sulfur-containing silane coupling agent: “Si75” manufactured by EVONIK Industries
Nitrogen-containing alkoxysilane 1: amino group-containing “3-aminopropyltriethoxysilane” manufactured by Tokyo Chemical Industry Co., Ltd.
Nitrogen-containing alkoxysilane 2: ureido group-containing “3-ureidopropyltriethoxysilane” manufactured by Tokyo Chemical Industry Co., Ltd., 40 mass % to 52 mass % methanol solution
Nitrogen-containing alkoxysilane 3: isocyanate group-containing “3-isocyanatopropyltriethoxysilane” manufactured by Tokyo Chemical Industry Co., Ltd.
Alkylalkoxysilane 1: “octadecyltriethoxysilane” manufactured by Tokyo Chemical Industry Co., ltd.
Alkylalkoxysilane 2: “propyltriethoxysilane” manufactured by Tokyo Chemical Industry Co., Ltd.
Sulfur: “Powdered sulfur” manufactured by Tsurumi Chemical Industry Co., Ltd.
Vulcanization accelerator 1: “SOXINOL CZ” manufactured by Sumitomo Chemical Co., Ltd.
Vulcanization accelerator 2: “NOCCELER D” manufactured by Ouchi Shinko Chemical Industrial Co., Ltd.

The expression “ratio (molar ratio (%)) of nitrogen-containing alkoxysilane in total amount of silane compound” in Tables 1 to 5 is the content ratio (mol %) of the nitrogen-containing alkoxysilane in the total content of the nitrogen-containing alkoxysilane and the alkylalkoxysilane. A blending amount of the nitrogen-containing alkoxysilane 2 in Table 5 is an amount containing methanol in a product.

The obtained vulcanized sample was subjected to a force curve measurement with an atomic force microscope. Specifically, the vulcanized rubber sample was elongated to 200%, and by using a cantilever AC-240TS-R3 (spring constant: 1.7 N/m), under the following measurement conditions, a force curve was measured at 128 points×128 points in a 3 μm×3 μm square, and thereby ease of deformation when a force was applied at each point was measured.

<Measurement Conditions>

Measurement frequency: 10 Hz

Pushing force: 2 nN

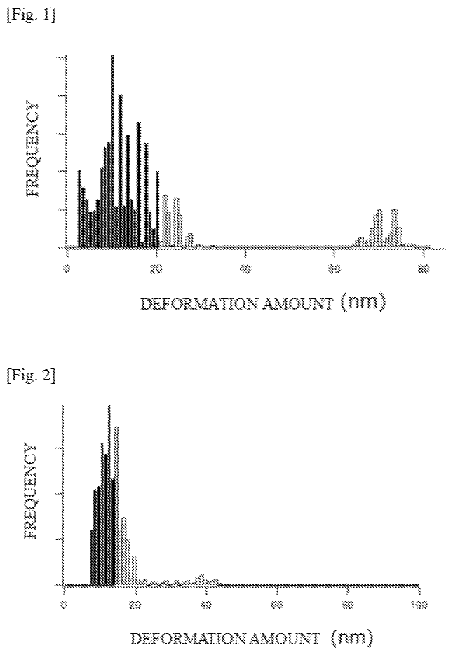

Since a filler hardly deforms, the deformation amount of the rubber component can be calculated by sequentially subtracting a volume fraction of the filler from a portion having a small deformation amount. As illustrated in FIGS. 1 and 2, histograms showing the deformation amount of the rubber component were created.

In addition, a weighted average value of the deformation amount was obtained by the following expression, and a ratio of a component having a deformation amount smaller than the weighted average value was calculated as a deformation margin of the rubber component.

Weighted average value: (each deformation amount×frequency)/total frequency

In FIGS. 1 and 2, one having a deformation amount smaller than the weighted average value is indicated by a black bar line, and one having a deformation amount larger than the weighted average value is indicated by a gray bar line. Since the deformation amount is not normally distributed, the weighted average value of the rubber composition in Example 1, which is flexible and follows the deformation well, is shifted to a right side (a side where the deformation amount is large) in the drawing, and thus the ratio of the component having a deformation amount smaller than the weighted average value increases.

In addition, durability (tensile product and modulus change) and heat generation performance of the obtained rubber composition were evaluated, and results were shown in Tables 1 to 5. Measurement methods for evaluation are as follows.
Tensile product: A rubber sheet having a thickness of 1 mm was prepared by using the obtained rubber composition, and the rubber sheet was vulcanized at 160° C. for 20 minutes. A tensile test (dumbbell No. 3) was performed in accordance with JIS K 6251 using an autograph manufactured by Shimadzu Corporation to measure tensile strength. The tensile strength at break Tb (MPa) and an elongation at break Eb (%) were calculated, and the tensile product (Tb×Eb÷100) was obtained. Values of the tensile product were expressed as indexes with a value in Comparative Example 1-1 in Table 1, a value in Comparative Example 2-1 in Table 2, a value in Comparative Example 3-1 in Table 3, a value in Comparative Example 4-1 in Table 4, and a value in Comparative Example 5-1 in Table 5 which were each set as 100. The larger the value of the tensile product, the higher the modulus, and the better the durability.
Modulus change: A rubber sheet having a thickness of 1 mm was prepared by using the obtained rubber composition, and the rubber sheet was vulcanized at 160° C. for 20 minutes. The obtained vulcanized rubber sheet was punched out in old JIS dumbbell No. 4 to prepare a sample. The obtained sample and the obtained sample after fatigue of 1 million cycles in 50% elongation were subjected to a tensile strength test, and the modulus at 100% elongation was measured for each thereof. The modulus before fatigue was set to 100, the modulus after fatigue was calculated, and a value obtained by subtracting the modulus after fatigue from the modulus before fatigue was set to the modulus change.

Comparative Example 1-1 in Table 1, Comparative Example 2-1 in Table 2, Comparative Example 3-1 in Table 3, Comparative Example 4-1 in Table 4, and Comparative Example 5-1 in Table 5 were each used as a reference. Those having a larger tensile product and a smaller absolute value of the modulus change were evaluated as “A” as having excellent durability, and those not satisfying these conditions were evaluated as “B” as having poor durability.
Heat generation performance: For the sample obtained by vulcanizing the obtained rubber composition at 160° C. for 20 minutes, a loss coefficient tan δ was measured at a frequency of 10 Hz, an electrostatic strain of 10%, a dynamic strain of 1%, and a temperature of 60° C. by using a viscoelasticity tester manufactured by Ueshima Seisakusho Co., Ltd. Measured values were expressed as indexes with a value in Comparative Example 1-1 in Table 1, a value in Comparative Example 2-1 in Table 2, a value in Comparative Example 3-1 in Table 3, a value in Comparative Example 4-1 in Table 4, and a value in Comparative Example 5-1 in Table 5 which were each set as 100. The smaller the index, the better the low fuel cost.

TABLE 1

| | Comparative | Comparative | Comparative | | | | Comparative | Comparative |
|---|---|---|---|---|---|---|---|---|
| | Example 1-1 | Example 1-2 | Example 1-3 | Example 1-1 | Example 1-2 | Example 1-3 | Example 1-4 | Example 1-5 |
| S-SBR | 100 | 100 | 100 | 100 | 100 | 100 | 100 | 100 |
| Silica | 30 | 30 | 30 | 30 | 30 | 30 | 30 | 30 |
| Zinc oxide | 2 | 2 | 2 | 2 | 2 | 2 | 2 | 2 |
| Stearic acid | 2 | 2 | 2 | 2 | 2 | 2 | 2 | 2 |
| Sulfur-containing | 2 | — | — | — | — | — | — | — |
| silane coupling agent | | | | | | | | |
| Nitrogen-containing | — | 1.1 | 0.9 | 0.5 | 0.3 | 0.1 | 0.09 | — |
| alkoxysilane 1 | | | | | | | | |
| Alkylalkoxysilane 1 | — | — | 0.3 | 1.0 | 1.5 | 1.6 | 1.8 | 2.0 |
| Alkylalkoxysilane 2 | — | — | — | — | — | — | — | — |
| Sulfur | 1.8 | 1.8 | 1.8 | 1.8 | 1.8 | 1.8 | 1.8 | 1.8 |
| Vulcanization | 1.3 | 1.3 | 1.3 | 1.3 | 1.3 | 1.3 | 1.3 | 1.3 |
| accelerator 1 | | | | | | | | |
| Vulcanization | 1.8 | 1.8 | 1.8 | 1.8 | 1.8 | 1.8 | 1.8 | 1.8 |
| accelerator 2 | | | | | | | | |
| Ratio (molar ratio (%)) | 0 | 100 | 83 | 50 | 25 | 10 | 8 | 0 |
| of nitrogen-containing | | | | | | | | |
| alkoxysilane in total | | | | | | | | |
| amount of silane compound | | | | | | | | |
| Deformation margin | 63 | 63 | 67 | 73 | 75 | 70 | 67 | 65 |
| Tensile product | 100 | 69 | 65 | 116 | 145 | 127 | 112 | 112 |
| Modulus reduction | 9 | 20 | 18 | 9 | 7 | 10 | 12 | 14 |
| Durability | — | B | B | A | A | A | B | B |
| Heat generation | 100 | 100 | 109 | 100 | 100 | 103 | 109 | 109 |
| performance | | | | | | | | |

TABLE 2

| | Comparative | Comparative | | | Comparative |
|---|---|---|---|---|---|
| | Example 2-1 | Example 2-2 | Example 2-1 | Example 2-2 | Example 2-3 |
| S-SBR | 100 | 100 | 100 | 100 | 100 |
| Silica | 50 | 50 | 50 | 50 | 50 |
| Zinc oxide | 2 | 2 | 2 | 2 | 2 |
| Stearic acid | 2 | 2 | 2 | 2 | 2 |
| Sulfur-containing | 4 | — | — | — | — |
| silane coupling agent | | | | | |
| Nitrogen-containing | — | 1.8 | 0.9 | 0.4 | — |
| alkoxysilane 1 | | | | | |
| Alkylalkoxysilane 1 | — | — | 1.7 | 2.5 | 3.3 |
| Alkylalkoxysilane 2 | — | — | — | — | — |
| Sulfur | 1.8 | 1.8 | 1.8 | 1.8 | 1.8 |
| Vulcanization | 1.3 | 1.3 | 1.3 | 1.3 | 1.3 |
| accelerator 1 | | | | | |
| Vulcanization | 1.8 | 1.8 | 1.8 | 1.8 | 1.8 |
| accelerator 2 | | | | | |
| Ratio (molar ratio (%)) | 0 | 100 | 50 | 25 | 0 |
| of nitrogen-containing | | | | | |
| alkoxysilane in total | | | | | |
| amount of silane compound | | | | | |
| Deformation margin | 62 | 60 | 74 | 77 | 65 |
| Tensile product | 100 | 34 | 58 | 68 | 56 |
| Modulus reduction | 20 | 30 | 14 | 16 | 20 |
| Durability | — | B | A | A | B |
| Heat generation | 100 | 61 | 61 | 61 | 72 |
| performance | | | | | |

TABLE 3

| | Comparative | Comparative | | | Comparative |
|---|---|---|---|---|---|
| | Example 3-1 | Example 3-2 | Example 3-1 | Example 3-2 | Example 3-3 |
| S-SBR | 100 | 100 | 100 | 100 | 100 |
| Silica | 75 | 75 | 75 | 75 | 75 |
| Zinc oxide | 2 | 2 | 2 | 2 | 2 |
| Stearic acid | 2 | 2 | 2 | 2 | 2 |
| Sulfur-containing | 6 | — | — | — | — |
| silane coupling agent | | | | | |
| Nitrogen-containing | — | 2.7 | 1.3 | 0.7 | — |
| alkoxysilane 1 | | | | | |
| Alkylalkoxysilane 1 | — | — | 2.5 | 3.8 | 5.0 |
| Alkylalkoxysilane 2 | — | — | — | — | — |
| Sulfur | 1.8 | 1.8 | 1.8 | 1.8 | 1.8 |
| Vulcanization | 1.3 | 1.3 | 1.3 | 1.3 | 1.3 |
| accelerator 1 | | | | | |
| Vulcanization | 1.8 | 1.8 | 1.8 | 1.8 | 1.8 |
| accelerator 2 | | | | | |
| Ratio (molar ratio (%)) | 0 | 100 | 50 | 25 | 0 |
| of nitrogen-containing | | | | | |
| alkoxysilane in total | | | | | |
| amount of silane compound | | | | | |
| Deformation margin | 60 | 59 | 77 | 78 | 66 |
| Tensile product | 100 | 95 | 162 | 189 | 155 |
| Modulus reduction | 40 | 50 | 25 | 20 | 30 |
| Durability | — | B | A | A | B |
| Heat generation | 100 | 99 | 103 | 103 | 113 |
| performance | | | | | |

TABLE 4

| | Comparative | Comparative | | |
|---|---|---|---|---|
| | Example 4-1 | Example 4-2 | Example 4-1 | Example 4-2 |
| S-SBR | 100 | 100 | 100 | 100 |
| Silica | 75 | 75 | 75 | 75 |
| Zinc oxide | 2 | 2 | 2 | 2 |
| Stearic acid | 2 | 2 | 2 | 2 |
| Sulfur-containing silane | 6 | — | — | — |
| coupling agent | | | | |
| Nitrogen-containing | — | 2.7 | 1.3 | 0.7 |
| alkoxysilane 1 | | | | |
| Alkylalkoxysilane 1 | — | — | — | — |
| Alkylalkoxysilane 2 | — | — | 1.2 | 1.9 |
| Sulfur | 1.8 | 1.8 | 1.8 | 1.8 |
| Vulcanization | 1.3 | 1.3 | 1.3 | 1.3 |
| accelerator 1 | | | | |
| Vulcanization | 1.8 | 1.8 | 1.8 | 1.8 |
| accelerator 2 | | | | |
| Ratio (molar ratio (%)) | 0 | 100 | 50 | 25 |
| of nitrogen-containing | | | | |
| alkoxysilane in total | | | | |
| amount of silane compound | | | | |
| Deformation margin | 60 | 59 | 72 | 75 |
| Tensile product | 100 | 95 | 123 | 187 |
| Modulus reduction | 40 | 50 | 35 | 40 |
| Durability | — | — | A | A |
| Heat generation | 100 | 99 | 103 | 103 |
| performance | | | | |

TABLE 5

| | Comparative | Comparative | | Comparative | | |
|---|---|---|---|---|---|---|
| | Example 5-1 | Example 5-2 | Example 5-1 | Example 5-3 | Example 5-2 | Example 5-3 |
| S-SBR | 100 | 100 | 100 | 100 | 100 | 100 |
| Silica | 75 | 75 | 75 | 75 | 75 | 75 |
| Zinc oxide | 2 | 2 | 2 | 2 | 2 | 2 |
| Stearic acid | 2 | 2 | 2 | 2 | 2 | 2 |
| Sulfur-containing | 6 | — | — | — | — | — |
| silane coupling agent | | | | | | |
| Nitrogen-containing | — | 6.3 | 3.2 | — | — | — |
| alkoxysilane 2 | | | | | | |
| Nitrogen-containing | — | — | — | 3.0 | 1.5 | 0.7 |
| alkoxysilane 3 | | | | | | |
| Alkylalkoxysilane 1 | — | — | 2.5 | — | 2.5 | 3.8 |
| Sulfur | 1.8 | 1.8 | 1.8 | 1.8 | 1.8 | 1.8 |
| Vulcanization | 1.3 | 1.3 | 1.3 | 1.3 | 1.3 | 1.3 |
| accelerator 1 | | | | | | |
| Vulcanization | 1.8 | 1.8 | 1.8 | 1.8 | 1.8 | 1.8 |
| accelerator 2 | | | | | | |
| Ratio (molar ratio (%)) | 0 | 100 | 50 | 100 | 50 | 25 |
| of nitrogen-containing | | | | | | |
| alkoxysilane in total | | | | | | |
| amount of silane compound | | | | | | |
| Deformation margin | 60 | 60 | 77 | 62 | 76 | 72 |
| Tensile product | 100 | 102 | 153 | 86 | 132 | 139 |
| Modulus reduction | 40 | 43 | 29 | 42 | 29 | 33 |
| Durability | — | B | A | B | A | A |
| Heat generation | 100 | 66 | 87 | 73 | 91 | 84 |
| performance | | | | | | |

The results are shown in Tables 1 to 5, and in each blending, Examples are excellent in durability as compared with Comparative Examples as references.

In addition, in the blending in Tables 1, 3, and 4, the heat generation performance in Examples can be maintained as compared with Comparative Examples as references, and in the blending in Tables 2 and 5, the heat generation performance in Examples is better than that of Comparative Examples as references.

### INDUSTRIAL APPLICABILITY

The rubber composition according to the invention can be used for a tread, a sidewall, a belt, a carcass, or the like of a tire for a passenger car or a large-sized tire for a truck or a bus.

What is claimed is:

1. A rubber composition comprising:
silica in a diene rubber, wherein
a deformation amount of a rubber component in a sample obtained by vulcanizing the rubber composition when the sample is elongated by 200% is obtained by a force curve measurement with an atomic force microscope, and a ratio of a rubber component having a deformation amount smaller than a weighted average value thereof is 70 vol % or more in the rubber component.

2. The rubber composition according to claim 1, further comprising:
a nitrogen-containing alkoxysilane; and
an alkylalkoxysilane.

3. The rubber composition according to claim 2, wherein
a content of the silica is 5 parts by mass to 150 parts by mass with respect to 100 parts by mass of the diene rubber,
a total content of the nitrogen-containing alkoxysilane and the alkylalkoxysilane is 3 mass % to 15 mass % with respect to the content of the silica, and
a content ratio of the nitrogen-containing alkoxysilane in the total content of the nitrogen-containing alkoxysilane and the alkylalkoxysilane is 10 mol % to 80 mol %.

4. The rubber composition according to claim 2, wherein
the nitrogen-containing alkoxysilane has at least one substituent selected from the group consisting of an amino group, a ureido group, an isocyanate group, a cyano group, an azide group, and an amide group.

5. The rubber composition according to claim 3, wherein
the nitrogen-containing alkoxysilane has at least one substituent selected from the group consisting of an amino group, a ureido group, an isocyanate group, a cyano group, an azide group, and an amide group.

6. The rubber composition according to claim 2, wherein
the alkylalkoxysilane is a compound represented by a Formula (1) 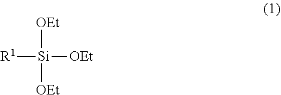
in the Formula (1), R¹ represents an alkyl group having 3 to 20 carbon atoms.

7. The rubber composition according to claim 3, wherein
the alkylalkoxysilane is a compound represented by a Formula (1) 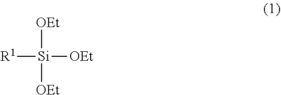
in the Formula (1), R¹ represents an alkyl group having 3 to 20 carbon atoms.

8. The rubber composition according to claim 4, wherein
the alkylalkoxysilane is a compound represented by a Formula (1) 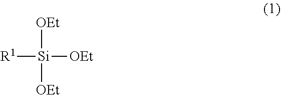
in the Formula (1), R¹ represents an alkyl group having 3 to 20 carbon atoms.

9. The rubber composition according to claim 5, wherein
the alkylalkoxysilane is a compound represented by a Formula (1) 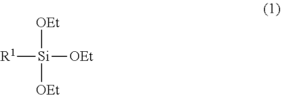
in the Formula (1), R¹ represents an alkyl group having 3 to 20 carbon atoms.

10. A pneumatic tire, which is produced using the rubber composition according to claim 1.

11. A pneumatic tire, which is produced using the rubber composition according to claim 2.

12. A pneumatic tire, which is produced using the rubber composition according to claim 3.

13. A pneumatic tire, which is produced using the rubber composition according to claim 4.

14. A pneumatic tire, which is produced using the rubber composition according to claim 5.

15. A pneumatic tire, which is produced using the rubber composition according to claim 6.

16. A pneumatic tire, which is produced using the rubber composition according to claim 7.

17. A pneumatic tire, which is produced using the rubber composition according to claim 8.

18. A pneumatic tire, which is produced using the rubber composition according to claim 9.
